(19) United States
(12) Patent Application Publication
(10) Pub. No.: US 2025/0023611 A1
(43) Pub. Date: Jan. 16, 2025

(54) TRANSMITTING CSI FOR MULTIPLE HYPOTHESES

(71) Applicant: Samsung Electronics Co., Ltd., Suwon-si (KR)

(72) Inventors: Jeongho Jeon, San Jose, CA (US); Aristides Papasakellariou, Houston, TX (US)

(21) Appl. No.: 18/759,631

(22) Filed: Jun. 28, 2024

Related U.S. Application Data
(60) Provisional application No. 63/526,844, filed on Jul. 14, 2023.
(60) Provisional application No. 63/531,989, filed on Aug. 10, 2023.

(51) Int. Cl. H04B 7/06; H04L 5/00; H04W 72/231

(52) U.S. Cl. CPC H04B 7/0626; H04L 5/0048; H04L 5/0057; H04W 72/231

(57) ABSTRACT

A method for a user equipment (UE) to report channel state information (CSI) includes receiving: first information related to a CSI reference signal (CSI-RS) resource set including one or more non-zero power CSI-RSs (NZP CSI-RSs) on a cell, second information related to a CSI report including a first number of CSI report sub-configurations corresponding to respective CSI sub-reports, third information related to association between the one or more NZP CSI-RSs and the respective first number of CSI report sub-configurations, fourth information related to indicating a second number of CSI report sub-configurations from the first number of CSI report sub-configurations, and the one or more NZP CSI-RSs based on the first information. The method further includes determining the second number of CSI sub-reports and transmitting an UL channel with the CSI report including the second number of CSI sub-reports.

### CROSS-REFERENCE TO RELATED APPLICATIONS AND CLAIM OF PRIORITY

The present application claims priority to U.S. Provisional Patent Application No. 63/526,844, filed on Jul. 14, 2023, and U.S. Provisional Patent Application No. 63/531,989, filed on Aug. 10, 2023. The contents of the above-identified patent documents are incorporated herein by reference.

### TECHNICAL FIELD

The present disclosure relates generally to wireless communication systems and, more specifically, the present disclosure relates to a transmission of channel status information (CSI) for multiple hypotheses in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a transmission of CSI for multiple hypotheses in a wireless communication system.

In one embodiment, a method for a user equipment (UE) to report CSI. The method includes receiving: first information related to a CSI reference signal (CSI-RS) resource set including one or more non-zero power CSI-RSs (NZP CSI-RSs) on a cell, second information related to a CSI report including a first number of CSI report sub-configurations corresponding to respective CSI sub-reports, third information related to association between the one or more NZP CSI-RSs and the respective first number of CSI report sub-configurations, fourth information related to indicating a second number of CSI report sub-configurations from the first number of CSI report sub-configurations, fifth information related to an uplink (UL) channel for transmitting the CSI report, and the one or more NZP CSI-RSs based on the first information. The fourth information is provided by: a downlink control information (DCI) format by indicating an index from one or more lists of indexes from the first number of CSI report sub-configurations, a medium access control control element (MAC CE), or a radio resource control (RRC) message. The method further includes determining the second number of CSI sub-reports based on the second information, the third information, the fourth information, and the reception of the one or more NZP CSI-RSs and transmitting the UL channel with the CSI report including the second number of CSI sub-reports. The determination of a CSI sub-report is based on a subset of NZP CSI-RSs associated with a corresponding CSI sub-configuration.

In another embodiment, a UE is provided. The UE includes a transceiver configured to receive: first information related to a CSI-RS resource set including one or more NZP CSI-RSs on a cell, second information related to a CSI report including a first number of CSI report sub-configurations corresponding to respective CSI sub-reports, third information related to association between the one or more NZP CSI-RSs and the respective first number of CSI report sub-configurations, fourth information related to indicating a second number of CSI report sub-configurations from the first number of CSI report sub-configurations, fifth information related to an UL channel for transmitting the CSI report, and the one or more NZP CSI-RSs based on the first information. The fourth information is provided by a DCI format by indicating an index from one or more lists of indexes from the first number of CSI report sub-configurations, a MAC CE, or a RRC message. The UE further includes a processor operably coupled to the transceiver. The processor is configured to determine the second number of CSI sub-reports based on the second information, the third information, the fourth information, and the reception of the one or more NZP CSI-RSs. The determination of a CSI sub-report is based on a subset of NZP CSI-RSs associated with a corresponding CSI sub-configuration. The transceiver is further configured to transmit the UL channel with the CSI report including the second number of CSI sub-reports.

In yet another embodiment, a base station (BS) is provided. The BS includes a processor and a transceiver operably coupled to the processor. The transceiver is configured to transmit: first information related to a CSI-RS resource set including one or more NZP CSI-RSs on a cell, second information related to a CSI report including a first number of CSI report sub-configurations corresponding to respective CSI sub-reports, third information related to association between the one or more NZP CSI-RSs and the respective first number of CSI report sub-configurations, fourth information related to indicating a second number of CSI report sub-configurations from the first number of CSI report sub-configurations, fifth information related to an UL channel for transmitting the CSI report, and the one or more NZP CSI-RSs based on the first information; and receive the UL channel with the CSI report including the second number of CSI sub-reports. A CSI sub-report is based on a subset of NZP CSI-RSs associated with a corresponding CSI sub-configuration. The fourth information is provided by a DCI format by indicating an index from one or more lists of indexes from the first number of CSI report sub-configurations, a MAC CE, or a RRC message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of antenna structure according to embodiments of the present disclosure;

FIG. 7 illustrates an example of cell DTX/DRX according to embodiments of the present disclosure;

FIG. 8 illustrates an example of spatial element adaptation according to embodiments of the present disclosure;

FIG. 9 illustrates a flowchart of a UE method for sending multiple CSI reports according to embodiments of the present disclosure;

FIG. 10 illustrates an example of CSI-RS beams with reduced spatial elements according to embodiments of the present disclosure;

FIG. 11 illustrates an example of association of CSI-RS resources with CSI report sub-configurations according to embodiments of the present disclosure;

FIG. 12 illustrates a flowchart of a UE method for providing multiple CSI reports for joint spatial and power domain adaptations according to embodiments of the present disclosure;

FIG. 13 illustrates an example of association of multiple power values with CSI report sub-configurations according to embodiments of the present disclosure;

FIG. 14 illustrates an example of power offset values via a differential value per CSI-RS resource according to embodiments of the present disclosure;

FIG. 15 illustrates an example of CSI reporting for a chosen CRI with additional PD adaptation hypotheses according to embodiments of the present disclosure;

FIG. 16 illustrates a flowchart of a UE method for providing multiple CSIs using PUCCH with a dropping rule according to embodiments of the present disclosure; and

FIG. 17 illustrates an example of UE CSI payload corresponding to multiple CSI report sub-configurations and power adaptation values according to embodiments of the present disclosure.

### DETAILED DESCRIPTION

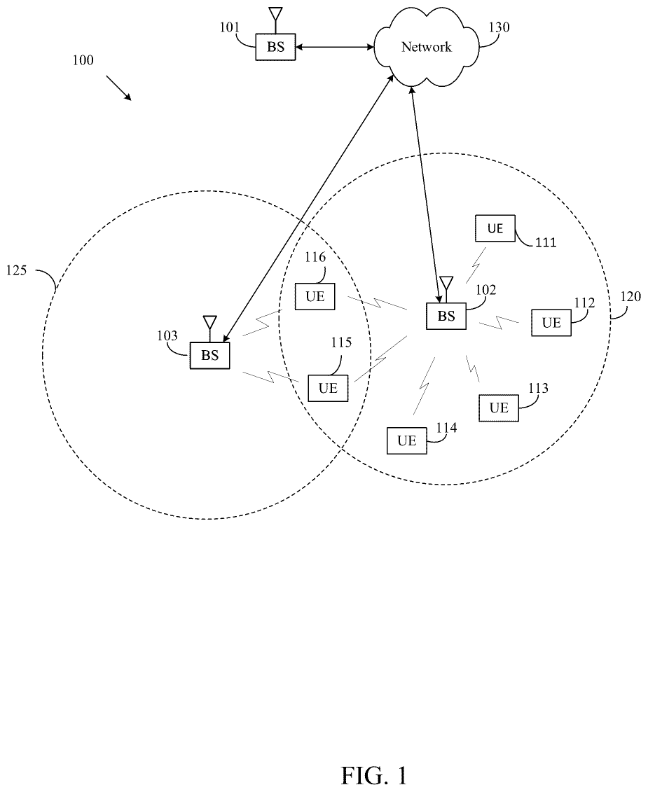

FIG. 1 through FIG. 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.5.0, “NR; Physical channels and modulation”; 3GPP TS 38.212 v17.5.0, “NR; Multiplexing and Channel coding”; 3GPP TS 38.213 v17.5.0, “NR; Physical Layer Procedures for Control”; 3GPP TS 38.214 v17.5.0, “NR; Physical Layer Procedures for Data”; 3GPP TS 38.331 v17.6.0, “NR; Medium Access Control (MAC) protocol specification”; 3GPP TS 38.331 v17.4.0, “NR; Radio Resource Control (RRC) Protocol Specification.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a transmission of CSI reporting for multiple hypothesis in a wireless communication system. In certain embodiments, and one or more of the gNBs 101-103 includes circuitry, programing, or a combination thereof, for supporting a transmission of CSI reporting for multiple hypothesis in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

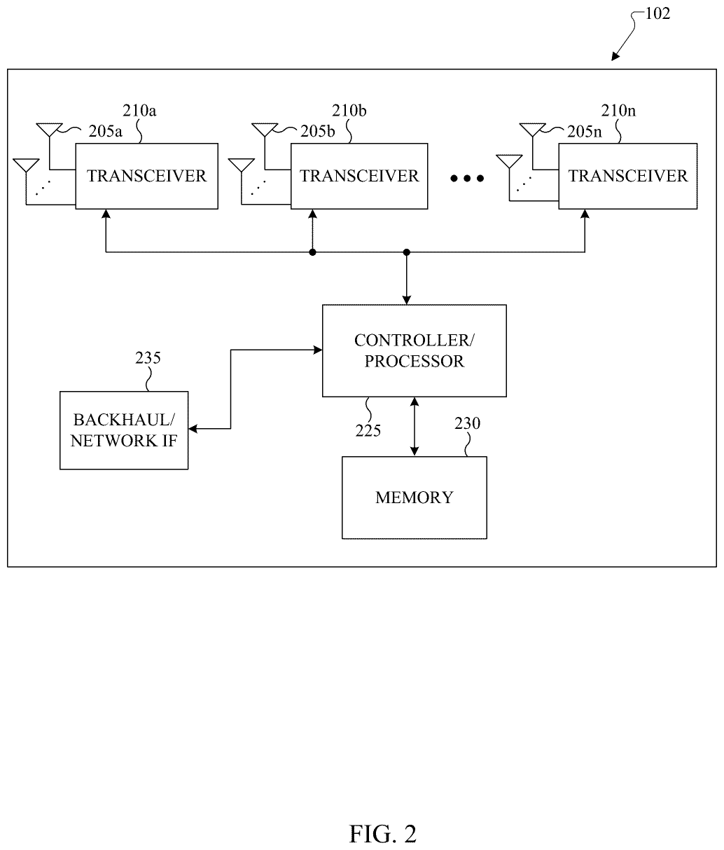

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a transmission of CSI reporting for multiple hypothesis in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

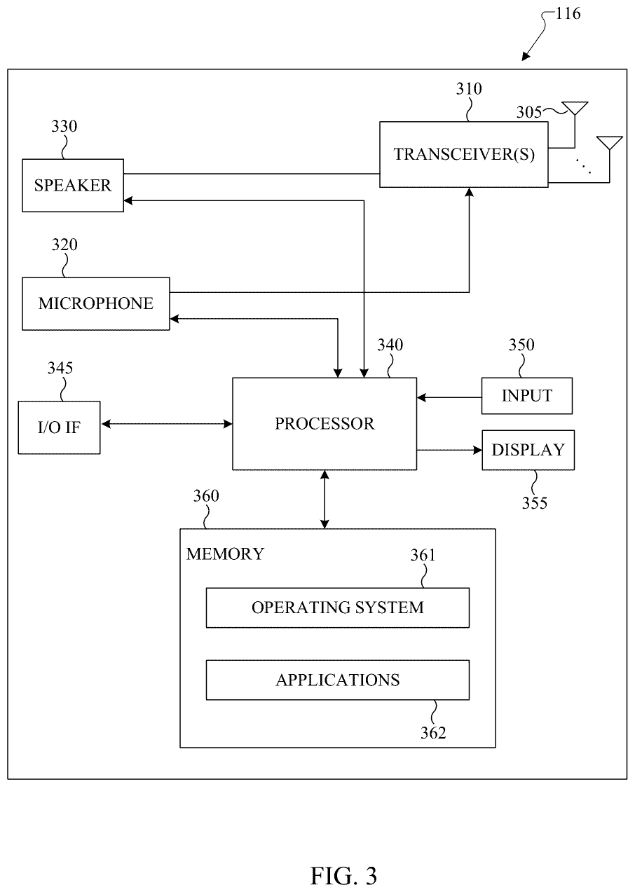

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a transmission of CSI reporting for multiple hypothesis in a wireless communication system.

The processor 340 can move data into or out of the memory 360 as required by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

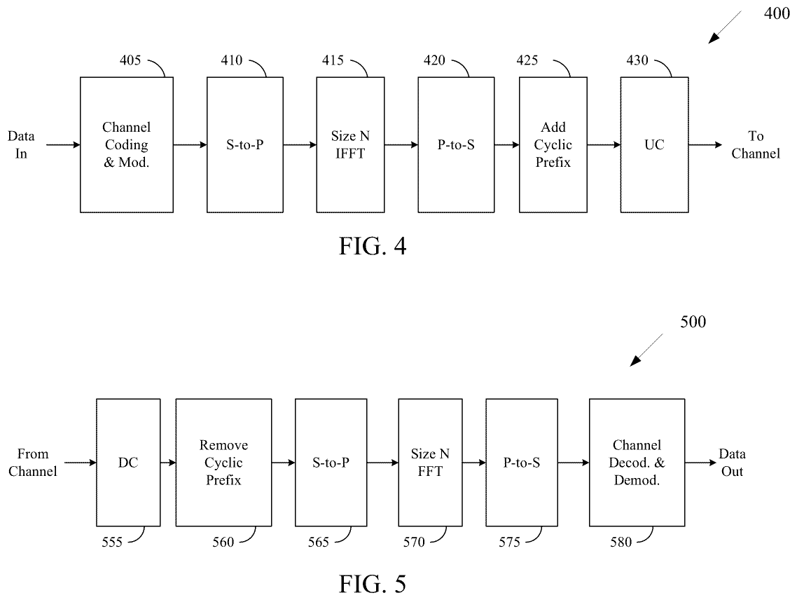

FIG. 4 and FIG. 5 illustrate example wireless transmit and receive paths according to this disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support a transmission of CSI reporting for multiple hypotheses in a wireless communication system as described in embodiments of the present disclosure.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system can include a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of one millisecond or 0.5 millisecond and an RB can have a bandwidth of 180 kHz or 720 kHz and include 12 SCs with inter-SC spacing of 15 kHz or 30 kHz respectively. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 3GPP specification, are referred for brevity as a unicast DCI format. A DCI format scheduling PDSCH reception for multicast communication, such as a DCI format with CRC scrambled by G-RNTI/G-CS-RNTI as described in 3GPP specification, are referred to as multicast DCI format. DCI formats providing various control information to at least a subset of UEs in a serving cell, such as DCI format 2_0 in 3GPP specification, are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH).

In this disclosure, a beam is determined by either of: (1) a TCI state, that establishes a quasi-colocation (QCL) relationship or spatial relation between a source reference signal (e.g., a synchronization signal block (SS/PBCH block or SSB) and/or channel state information reference signal (CSI-RS)) and a target reference signal; or (2) a spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

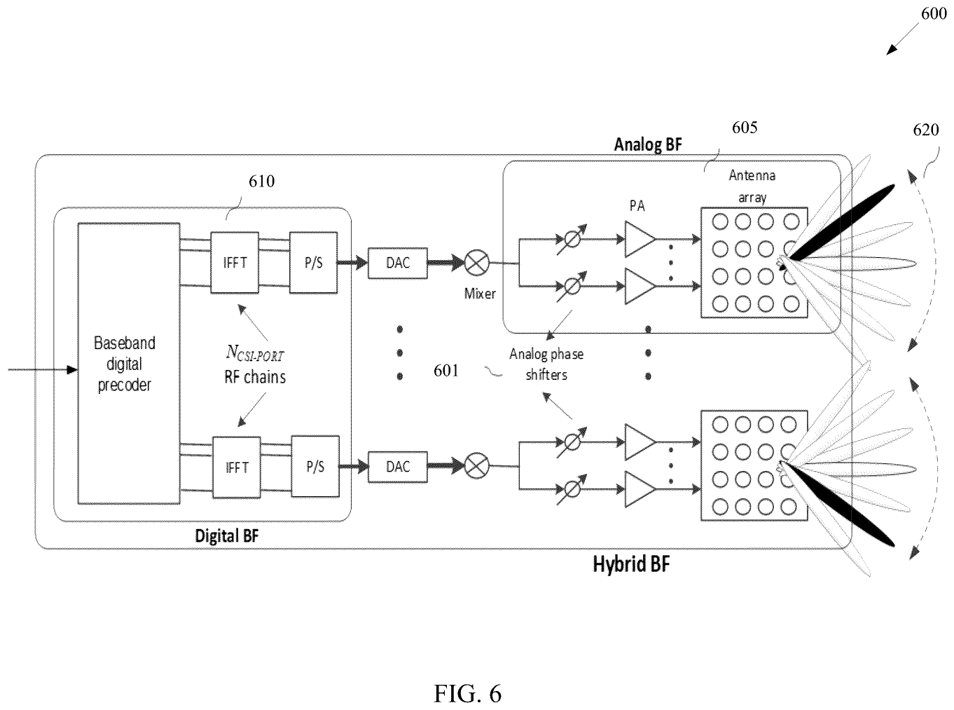

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be needed to compensate for the additional path loss.

The present disclosure relates generally to wireless communication systems and, more specifically, to procedures for enabling network energy savings. Network energy savings is important for environmental sustainability, to reduce environmental impact (greenhouse gas emissions), and for operational cost savings. With the wireless communications industry projected to potentially contribute as much as 20% of the global energy consumption by 2030, communications networks may be attentive to global priorities pertaining to climate change, especially the reduction of energy consumption. Also, energy consumption has become a key part of the operators' OPEX. According to the report from GSMA, the energy cost on mobile networks accounts for ˜23% of the total operator cost. Most of the energy consumption occurs at the radio access network and in particular at the active antenna unit (AAU), with data centers and fiber transport accounting for a smaller share. The energy consumption for radio access can be split into two parts: a dynamic part that occurs only when data transmission/reception is active, and a static part that occurs in order to maintain the necessary operation of the radio access devices, even when data transmission/reception is not active.

As 5G is becoming pervasive across industries and geographical areas, handling more advanced services and applications requiring very high data rates (e.g., XR), networks are being denser, use more antennas, larger bandwidths and more frequency bands. For example, network densification increases the number of transmission points, higher carrier frequencies lend themselves to larger numbers of antennas, and for the case of higher spectrum bands, e.g., mmW or sub-THz/THz spectrum, the frequencies of operation trend towards wider bandwidths resulting in worse impairment characteristics for RF electronics along with higher sampling rates for digital processes and data converters. High clock rates demand power consumption that increases approximately with linear proportionality. This trend will continue in 6G.

Therefore, the environmental impact of 5G as well as future 6G needs to stay under control, and novel solutions to improve network energy savings need to be developed. These solutions could allow to achieve more efficient operation dynamically and/or semi-statically and finer granularity adaptation of transmissions and/or receptions in one or more of network energy savings techniques in time, frequency, spatial, and power domains, with potential support/feedback from a UE, potential UE assistance information, and information exchange/coordination over network interfaces.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

For each DL bandwidth part (BWP) indicated to a UE in a serving cell, the UE can be provided by higher layer signaling with P≤3 control resource sets (CORESETs). For each CORESET, the UE is provided a CORESET index p, 0≤p<12, a DM-RS scrambling sequence initialization value, a precoder granularity for a number of resource element groups (REGs) in the frequency domain where the UE can assume use of a same DM-RS precoder, a number of consecutive symbols for the CORESET, a set of resource blocks (RBs) for the CORESET, CCE-to-REG mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE is provided by higher layers with S≤10 search space sets. For each search space set from the S search space sets, the UE is provided a search space set index s, 0≤s<40, an association between the search space set s and a CORESET p, a PDCCH monitoring periodicity of kₛ slots and a PDCCH monitoring offset of oₛ slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a CSS set or a USS set. When search space set s is a CSS set, the UE monitors PDCCH for detection of DCI format 2_x, where x ranges from 0 to 7 as described in TS 38.212 v17.4.0, or for DCI formats associated with scheduling broadcast/multicast PDSCH receptions, and possibly for DCI format 0_0 and DCI format 1_0.

A UE determines a PDCCH monitoring occasion on an active DL BWP from the PDCCH monitoring periodicity, the PDCCH monitoring offset, and the PDCCH monitoring pattern within a slot. For search space set s, the UE determines that a PDCCH monitoring occasion(s) exists in a slot with number n_{s,f}^{μ} in a frame with number n_{f} if (n_{f}·Nₛₗₒₜ^{frame,μ}+n_{s,f}^{μ}−oₛ) mod kₛ=0. The UE monitors PDCCH candidates for search space set s for Tₛ consecutive slots, starting from slot n_{s,f}^{μ}, and does not monitor PDCCH candidates for search space set s for the next kₛ−Tₛ consecutive slots. The UE determines CCEs for monitoring PDCCH according to a search space set based on a search space equation as described in 3GPP specification TS 38.213.

A UE is expected to monitor PDCCH candidates for up to 4 sizes of DCI formats that include up to 3 sizes of DCI formats with CRC scrambled by C-RNTI per serving cell. The UE counts a number of sizes for DCI formats per serving/scheduled cell based on a number of PDCCH candidates in respective search space sets for the corresponding active DL BWP. In the following, for brevity, that constraint for the number of DCI format sizes may be referred to as DCI size limit. When the DCI size limit may be exceeded for a UE based on a configuration of DCI formats that the UE monitors PDCCH, the UE aligns the size of some DCI formats, as described in 3GPP specification TS 38.212 so that the DCI size limit may not be exceeded.

For each scheduled cell, the UE is not required to monitor on the active DL BWP with SCS configuration μ of the scheduling cell more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot, wherein M_{PDCCH}^{max,slot,μ} and C_{PDCCH}^{max,slot,μ} are respectively a maximum number of PDCCH candidates and non-overlapping CCEs for a scheduled cell and M_{PDCCH}^{total,slot,μ} and C_{PDCCH}^{total,slot,μ} are respectively a total number of PDCCH candidates and non-overlapping CCEs for a scheduling cell, as described in 3GPP specification TS 38.213.

A UE does not expect to be configured CSS sets, other than CSS sets for multicast PDSCH scheduling, that result to corresponding total, or per scheduled cell, numbers of monitored PDCCH candidates and non-overlapped CCEs per slot on the primary cell that exceed the corresponding maximum numbers per slot. For USS sets or for CSS sets associated with multicast PDSCH scheduling, when a number of PDCCH candidates or non-overlapping CCEs in a slot may exceed the aforementioned limits/maximum per slot for scheduling on the primary cell, the UE selects the USS sets or the CSS sets to monitor corresponding PDCCH in an ascending order of a corresponding search space set index until and an index of a search space set for which PDCCH monitoring may result to exceeding the maximum number of PDCCH candidates or non-overlapping CCEs per slot for scheduling on the PCell as described in 3GPP specification TS 38.213.

For same cell scheduling or for cross-carrier scheduling where a scheduling cell and scheduled cells have DL BWPs with same SCS configuration u, a UE does not expect a number of PDCCH candidates, and a number of corresponding non-overlapped CCEs per slot on a secondary cell to be larger than the corresponding numbers that the UE is capable of monitoring on the secondary cell per slot. For cross-carrier scheduling, the number of PDCCH candidates for monitoring and the number of non-overlapped CCEs per slot are separately counted for each scheduled cell.

A UE can be configured for an operation with carrier aggregation (CA) for PDSCH receptions over multiple cells (DL CA) or for PUSCH transmissions over multiple cells (UL CA). The UE can also be configured multiple transmission-reception points (TRPs) per cell via indication (or absence of indication) of a coresetPoolIndex for CORESETs where the UE receives PDCCH/PDSCH from a corresponding TRP as described in 3GPP specification TS 38.213 and TS 38.214.

MIMO technologies have a key role in boosting system throughput both in NR and LTE and such a role will continue and further expand in the future generations of wireless technologies.

For a MIMO operation, an antenna port is defined such that a channel over which a symbol on the antenna port is conveyed can be inferred from the channel over which another symbol on the same antenna port is conveyed. There is not necessarily one to one correspondence between an antenna port and an antenna element, and a plurality of antenna elements can be mapped onto one antenna port.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) “CLASS A” CSI reporting that corresponds to non-precoded CSI-RS, 2) “CLASS B” CSI reporting with K=1 CSI-RS resource that corresponds to UE-specific beamformed CSI-RS, and 3) “CLASS B” reporting with K>1 CSI-RS resources that corresponds to cell-specific beamformed CSI-RS. For non-precoded (NP) CSI-RS, a cell-specific one-to-one mapping between CSI-RS port and TXRU is utilized. Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For MU-MIMO, in particular, availability of accurate CSI is necessary in order to guarantee robust MU performance and avoid interference among transmissions to different UEs. For TDD systems, CSI can be acquired using SRS transmissions from UEs by relying on DL/UL channel reciprocity. For FDD systems, a gNB can acquire CSI by transmitting CSI-RS and obtaining corresponding CSI reports from UEs. A CSI reporting framework can be “implicit” in the form of CQI/PMI/RI, and possibly CRI, as derived from a codebook assuming SU transmission from the eNB. Because of the inherent SU assumption while deriving CSI, implicit CSI feedback is inadequate for MU transmissions. For MU-centric operation, a high-resolution Type-II codebook, in addition to low resolution Type-I codebook, can be used.

A serving gNB can configure Type-I and Type-II CSI codebooks to a UE using higher layer signalling to provide a CodebookConfig IE, as described in 3GPP specification TS 38.331 that includes the following parameters: (1) codebookType includes type1, type2 and possibly sub-types such as type1-SinglePanel, type1-MultiPanel, typeII, and typeII-PortSelection, and corresponding parameters for each type; (2) n1-n2 configures a number of antenna ports in first (n1) and second (n2) dimension and codebook subset restriction for type1-SinglePanel; (3) ng-n1-n2 configures a number of antenna panels (ng), a number of antenna ports in first (n1) and second (n2) dimension assuming that the antenna structure is identical for the configured number of panels, and a codebook subset restriction for Type I Multi-panel codebook; (4) n1-n2-codebookSubsetRestriction configures a number of antenna ports in first (n1) and second (n2) dimension and a codebook subset restriction for typeII; and (5) CodebookConfig-r17 includes type1-SinglePanel1-r17 and type1-SinglePanel2-r17 for typeI to enable configuration of different antenna structures for two TRPs.

The IE RS-ResourceMapping indicates a resource element mapping for a CSI-RS resource in the time and frequency domains. The container of the IE includes elements for configuration of time and frequency domain resources such as by firstOFDMSymbolInTimeDomain, firstOFDMSymbolInTimeDomain2, and frequencyDomainAllocation, the CSI-RS density by density, the number of ports by nrofPorts, and others. The IE CSI-RS-ResourceMapping comprises the NZP-CSI-RS-Resource and ZP-CSI-RS-Resource configurations that are included in the CSI-ResourceConfig. The IE CSI-ResourceConfig defines a group of one or more NZP-CSI-RS-ResourceSet, CSI-IM-ResourceSet and/or CSI-SSB-ResourceSet.

The IE CSI-ReportConfig is used to indicate to UE parameters for providing a periodic or semi-persistent CSI report via PUCCH transmissions on the cell where CSI-ReportConfig is included, or to indicate parameters for providing a semi-persistent or aperiodic CSI report on a PUSCH as triggered by a DCI that the UE receives. The CSI-ReportConfig is set for certain CSI-ResourceConfigId for channel/interference measurements. The aforementioned CodebookConfig is also part of CSI-ReportConfig.

For aperiodic CSI, both aperiodic CSI reporting and aperiodic CSI-RS transmission are triggered using a “CSI request” field within a DCI format scheduling a PUSCH transmission, such as DCI format 0_1. The “CSI Request” field indicates a “trigger state” that points to a certain CSI-ReportConfigId and resourcesForChannel, e.g., NZP-CSI-RS-ResourceSet. The “CSI request” field can have up to 6 bits and can indicate up to 64 “Trigger States.” If a UE is configured with more than 64 “trigger states,” a “aperiodic CSI trigger state subselection” MAC CE identifies a subset of trigger states that are indicated by DCI. A CSI-AperiodicTriggerState can include a number of CSI-AssociatedReportConfigInfo, which provides linked CSI-ReportConfigId and resourcesForChannel.

For semi-persistent CSI on PUCCH, the semi-persistent CSI-RS resource is triggered by a “SP CSI-RS/CSI-IM resource set activation/deactivation” MAC CE that includes a SP CSI-RS resource set ID indicating an index of NZP-CSI-RS-ResourceSet containing semi persistent NZP CSI-RS resources indicating the semi persistent NZP CSI-RS resource set, that is to be activated or deactivated. Semi-persistent CSI reporting on PUCCH is triggered using the “SP CSI reporting on PUCCH activation/deactivation” MAC CE.

The field Sᵢ in the MAC CE indicates the activation/deactivation status of the semi-persistent CSI report configuration within csi-ReportConfigToAddModList. S₀ refers to the report configuration that includes PUCCH resources for semi-persistent CSI reporting in the indicated BWP and has the lowest CSI-ReportConfigId within the list with type set to semiPersistentOnPUCCH, S₁ refers to the report configuration that includes PUCCH resources for semi-persistent CSI reporting in the indicated BWP and has the second lowest CSI-ReportConfigId, and so on.

For semi-persistent CSI reporting on PUSCH, a CSI report is triggered using a “CSI request” field in a DCI format 0_1 with CRC scrambled by a SP-CSI-RNTI. The operating details are similar to those for an aperiodic CSI report.

For periodic CSI reporting, both reporting and periodic CSI-RS resources are configured and initiated by CSI-ReportConfig.

A UE is semi-statically configured by higher layers to perform periodic CSI reporting on the PUCCH. A UE can be configured by higher layers for multiple periodic CSI reports corresponding to multiple higher layer configured CSI reporting settings, where the associated CSI resource settings are higher layer configured. Periodic CSI reporting on PUCCH formats 2, 3, 4 supports Type I CSI with wideband granularity.

A UE may perform semi-persistent CSI reporting on the PUCCH applied starting from the first slot that is after slot n+3Nₛₗₒₜ^{subframe,μ}, when the UE may transmit a PUCCH with HARQ-ACK information in slot n corresponding to the PDSCH carrying the activation command described in 3GPP specification where μ is the SCS configuration for the PUCCH. The activation command may contain one or more reporting settings where the associated CSI resource settings are configured. Semi-persistent CSI reporting on the PUCCH supports Type I CSI. Semi-persistent CSI reporting on the PUCCH format 2 supports Type I CSI with wideband frequency granularity. Semipersistent CSI reporting on PUCCH formats 3 or 4 supports Type I CSI with wideband and sub-band frequency granularities and Type II CSI Part 1.

When the PUCCH carry Type I CSI with wideband frequency granularity, the CSI payload carried by the PUCCH format 2 and PUCCH formats 3, or 4 are identical and the same irrespective of RI (if reported), CRI (if reported). A CSI-ReportConfig with codebookType set to “typeI-SinglePanel” and the corresponding CSI-RS resource set for channel measurement configured with two resource groups and N resource pairs can be configured with wideband frequency granularity only with csi-ReportMode set to “Model” and numberOfSingleTRP-CSI-Model set to X=0. For type I CSI sub-band reporting on PUCCH formats 3, or 4, the payload is split into two parts.

The first part contains RI (if reported), CRI (if reported), CQI for the first codeword. The second part contains PMI (if reported), LI (if reported) and contains the CQI for the second codeword (if reported) when RI>4. For a CSI-ReportConfig configured with subband reporting, codebookType set to “typeI-SinglePanel” and the corresponding CSI-RS resource set for channel measurement configured with two resource groups and N resource pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

A semi-persistent report carried on the PUCCH formats 3 or 4 supports Type II CSI feedback, but only Part 1 of Type II CSI feedback (See 3GPP specification). Supporting Type II CSI reporting on the PUCCH formats 3 or 4 is a UE capability type2-SP-CSI-Feedback-LongPUCCH. A Type II CSI report (Part 1 only) carried on PUCCH formats 3 or 4 may be calculated independently of any Type II CSI reports carried on the PUSCH (see 3GPP specification).

When the UE is configured with CSI Reporting on PUCCH formats 2, 3 or 4, each PUCCH resource is configured for each candidate UL BWP.

If the UE is in an active semi-persistent CSI reporting configuration on PUCCH and has not received a deactivation command, the CSI reporting takes place when the BWP in which the reporting is configured to take place is the active BWP, otherwise the CSI reporting is suspended.

A UE is not expected to report CSI with a total number of UCI bits and CRC bits larger than 115 bits when configured with PUCCH format 4. For CSI reports transmitted on a PUCCH, if all CSI reports includes one part, the UE may omit a portion of CSI reports. Omission of CSI is according to the priority order determined from the Pri_{i,CSI}(y,k,c,s) value as defined in 3GPP specification. CSI report is omitted beginning with the lowest priority level until the CSI report code rate is less or equal to the one configured by the higher layer parameter maxCodeRate.

If any of the CSI reports include two parts, the UE may omit a portion of Part 2 CSI. Omission of Part 2 CSI is according to the priority order shown in 3GPP specification. Part 2 CSI is omitted beginning with the lowest priority level until the Part 2 CSI code rate is less or equal to the one configured by higher layer parameter maxCodeRate.

A UE may perform aperiodic CSI reporting using PUSCH on serving cell c upon successful decoding of a DCI format 0_1 or DCI format 0_2 which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

An aperiodic CSI report carried on the PUSCH supports wideband, and sub-band frequency granularities. An aperiodic CSI report carried on the PUSCH supports Type I, Type II, enhanced type II and further enhanced Type II port selection CSI.

A UE may perform semi-persistent CSI reporting on the PUSCH upon successful decoding of a DCI format 0_1 or DCI format 0_2 which activates a semi-persistent CSI trigger state. DCI format 0_1 and DCI format 0_2 contains a CSI request field which indicates the semi-persistent CSI trigger state to activate or deactivate. Semi-persistent CSI reporting on the PUSCH supports Type I, Type II with wideband, and sub-band frequency granularities, enhanced Type II and further enhanced Type II port selection CSI. The PUSCH resources and MCS may be allocated semi-persistently by an uplink DCI.

CSI reporting on PUSCH can be multiplexed with uplink data on PUSCH except that semi-persistent CSI reporting on PUSCH activated by a DCI format is not expected to be multiplexed with uplink data on the PUSCH. CSI reporting on PUSCH can also be performed without any multiplexing with uplink data from the UE.

Type I CSI feedback is supported for CSI reporting on PUSCH. Type I wideband and sub-band CSI is supported for CSI reporting on the PUSCH. Type II CSI is supported for CSI reporting on the PUSCH.

For Type I, Type II, Enhanced Type II and further enhanced Type II port detection CSI feedback on PUSCH, a CSI report comprises of two parts. Part 1 has a fixed payload size and is used to identify the number of information bits in Part 2. Part 1 may be transmitted in its entirety before Part 2.

For Type I CSI feedback, Part 1 contains RI (if reported), CRI (if reported), CQI for the first codeword (if reported). Part 2 contains PMI (if reported), LI (if reported) and contains the CQI for the second codeword (if reported) when RI is larger than 4. For a CSI-ReportConfig configured with codebookType set to “typeISinglePanel” and the corresponding CSI-RS resource set for channel measurement configured with two resource groups and N resource pairs, Part 1 contains RI(s), CRI(s), CQI(s) for the first codeword and is zero padded to a fixed payload size (if needed). Part 2 contains the CQI(s) for the second codeword (if reported) when RI is larger than 4, LIs (if reported) and PMI(s).

For Type II CSI feedback, Part 1 contains RI (if reported), CQI, and an indication of the number of non-zero wideband amplitude coefficients per layer for the Type II CSI (see 3GPP specification). The fields of Part 1—RI (if reported), CQI, and the indication of the number of non-zero wideband amplitude coefficients for each layer—are separately encoded. Part 2 contains the PMI and LI (if reported) of the Type II CSI. The elements of i_{1,4,l}, i_{2,1,l} (if reported) and i_{2,2,l} (if reported) are reported in the increasing order of their indices, i=0,1, . . . , 2L−1, where the element of the lowest index is mapped to the most significant bits and the element of the highest index is mapped to the least significant bits. Part 1 and 2 are separately encoded.

For Enhanced Type II CSI feedback (see 3GPP specification) and further enhanced Type II port selection CSI feedback (see 3GPP specification), Part 1 contains RI (if reported), CQI, and an indication of the overall number of non-zero amplitude coefficients across layers. The fields of Part 1—RI (if reported), CQI, and the indication of the overall number of non-zero amplitude coefficients across layers—are separately encoded. Part 2 contains the PMI of the enhanced Type II or further enhanced Type II Port selection CSI. Part 1 and 2 are separately encoded.

A Type II CSI report that is carried on the PUSCH may be computed independently from any Type II CSI report that is carried on the PUCCH formats 3 or 4 (see 3GPP specification).

When the higher layer parameter reportQuantity is configured with one of the values “cri-RSRP,” “ssb-Index-RSRP,” “cri SINR” or “ssb-Index-SINR,” or “cri-RSRP-Capability[Set]Index,” “ssb-Index-RSRP-Capability[Set]Index,” “cri-SINRCapability[Set]Index,” “ssb-Index-SINR-Capability[Set]Index,” the CSI feedback includes a single part.

For both Type I and Type II reports configured for PUCCH but transmitted on PUSCH, the determination of the payload for CSI part 1 and CSI part 2 follows that of PUCCH as described in 3GPP specification.

When CSI reporting on PUSCH comprises two parts, the UE may omit a portion of the Part 2 CSI. Omission of Part 2 CSI is according to the priority order shown in 3GPP specification, where N_{Rep} is the number of CSI reports configured to be carried on the PUSCH. Priority 0 is the highest priority and priority 2N_{Rep} is the lowest priority and the CSI report n corresponds to the CSI report with the nth smallest Pri_{i,CSI}(y,k,c,s) value among the N_{Rep} CSI reports as defined in 3GPP specification. The subbands for a given CSI report n indicated by the higher layer parameter csi-ReportingBand are numbered continuously in increasing order with the lowest subband of csi-ReportingBand as subband 0. When omitting Part 2 CSI information for a particular priority level, the UE may omit all of the information at that priority level.

Present networks have limited capability to adapt an operation state in one or more of time/frequency/spatial/power domains. For example, in NR, there are transmissions or receptions by a serving gNB that are expected by UEs, such as transmissions of synchronization signal/physical broadcast channel (SS/PBCH) blocks, or of system information, or of CSI-RS indicated by higher layers, or receptions of physical random access channel (PRACH) or sounding reference signal (SRS) indicated by higher layers. Reconfiguration of a NW operation state involves higher layer signaling by a system information block (SIB) or by UE-specific RRC.

That is a slow process and requires substantial signaling overhead, particularly for UE-specific RRC signaling. For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to frequently transmit SS/PBCH blocks, such as every 5 msec or every 20 msec and, in time division duplex (TDD) systems with UL-DL configurations having few UL symbols in a period, the serving gNB may need to receive PRACH or SRS in most UL symbols in a period.

Due to the above reasons, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality may be limited or none, is currently limited as there are no procedures for a serving gNB to perform fast adaptation of a NW operation state with small signaling overhead while simultaneously informing all UEs of the NW operation state.

It is also beneficial to support a gradual transition of NW operation states between a maximum state where the NW operates at its maximum capability in one or more of a time/frequency/spatial/power domain and a minimum state where the NW operates at its minimum capability or the NW enters a sleep mode. That may allow continuation of service while the NW transitions from a state with larger utilization of time/frequency/spatial/power resources to a state with lower utilization of such resources and the reverse as UEs can obtain time/frequency synchronization and AGC alignments, perform measurements and provide CSI reports or transmit SRS prior to scheduling of PDSCH receptions or PUSCH transmissions.

In order to enable a gNB to sleep and save energy while minimizing an impact on served UEs, the gNB can apply discontinued transmissions (cell DTX) or discontinued receptions (cell DRX) on a serving cell. UEs in the cell can be informed of corresponding cell DTX/DRX configurations such that the UEs can operate accordingly and avoid power consumption when the serving gNB is in dormancy (cell DTX/DRX). By turning off all or a part of a transmission chain and pausing transmission during the cell DTX, the gNB can reduce energy consumption for standby when there is little to no traffic.

For cell DTX, a UE may assume that all transmissions from a serving gNB are suspended or the UEs may assume that some signals, such as PSS or SSS for maintaining synchronization, remain present during cell DTX. By turning off all or a part of receiver chain and pausing receptions during the cell DRX, the gNB can reduce energy consumption for standby when there is little to no traffic. For cell DRX, a UE may assume that all transmissions from the UE are suspended or may assume that some transmissions, such as ones required for initial access such as PRACH, are allowed during a cell DRX duration.

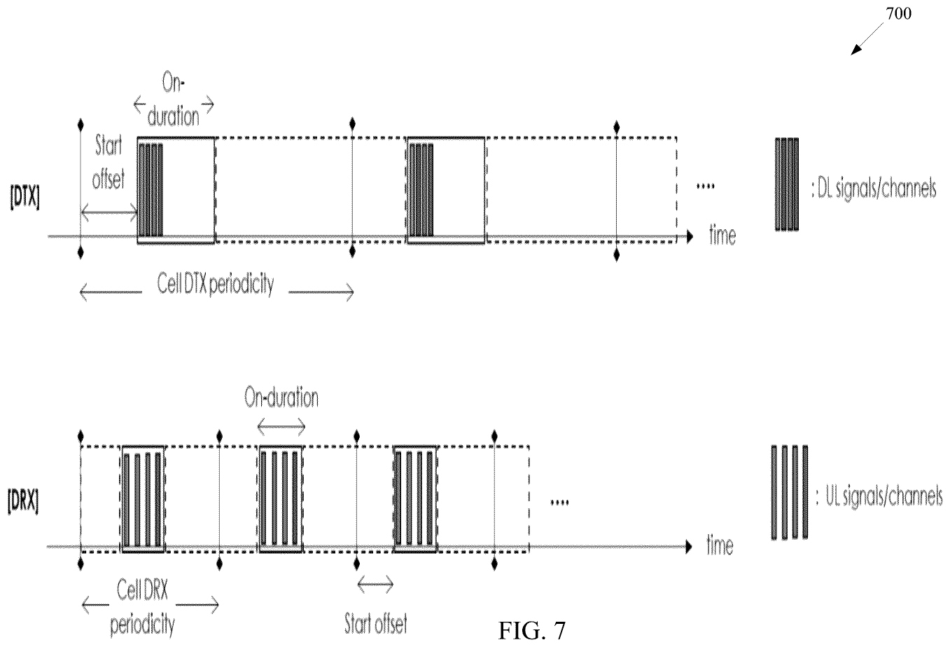

FIG. 7 illustrates an example of cell DTX/DRX 700 according to embodiments of the present disclosure. An embodiment of the cell DTX/DRX 700 shown in FIG. 7 is for illustration only.

As illustrated in FIG. 7, cell DTX/DRX can be configured via at least a periodicity, a start slot/offset, and an on-duration. A UE assumes that all transmissions/receptions by the gNB are enabled during the DTX/DRX on-duration, respectively. The configurations and operations of cell DTX and cell DRX can be linked or can be separate, for example depending on DL/UL traffic characteristics.

The energy consumption by power amplifiers (PA) for each set of antenna elements (AEs) accounts for a large portion of total energy consumption by a gNB equipped with massive MIMO antennas. For network energy savings, when the traffic load is low, the gNB can turn off a subset of PAs or reduce the PA output power levels. For brevity, such operation is respectively referred to as spatial domain (SD) or power domain (PD) adaptation in this embodiment of the disclosure. Unlike cell DTX/DRX illustrated in FIG. 7, one advantage of SD/PD adaptation is that the network can maintain continuity of transmissions and receptions without interruptions by operating at a reduced capability.

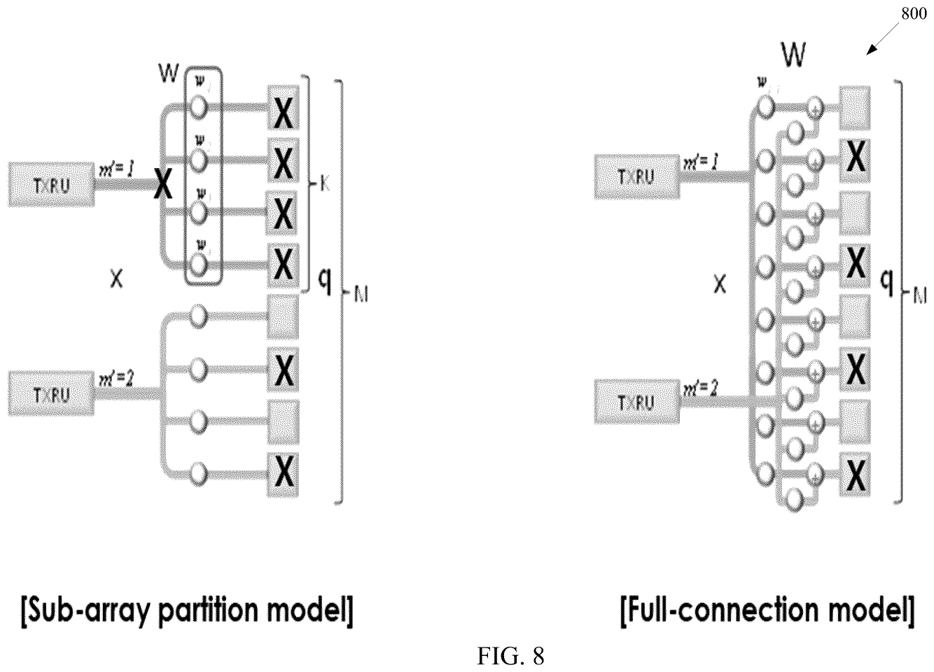

FIG. 8 illustrates an example of spatial element adaptation 800 according to embodiments of the present disclosure. An embodiment of the spatial element adaptation 800 shown in FIG. 8 is for illustration only.

A gNB can enable/disable all AEs associated to a logical antenna port or enable/disable a subset of AEs associated to a logical antenna port. For brevity, those adaptations of AEs are respectively referred to as Type 1 and Type 2 SD adaptations in this embodiment of the disclosure. The gNB may perform Type 1 SD adaptation, or Type 2 SD adaptation, or both.

In a hybrid beamforming system as illustrated in FIG. 8, one antenna port is connected to a large number of AEs that can be controlled by a bank of analog phase shifters, which is referred to as TxRU virtualization. The TxRU virtualization can be implemented based on sub-array partition model, full-connection model, or combinations of them, as illustrated in FIG. 8. In a sub-array partition model, spatial element adaptations can result in both Type 1 and Type 2 SD adaptations. In case of Type 1 SD adaptation, both the PAs connected to AEs associated to a logical antenna port and the subsequent RF chain, e.g., ADC/DAC, etc., associated to the logical antenna port can be turned off. In a full-connection model, spatial element adaptations can only result in Type 2 SD adaptations unless all the antenna ports are turned off.

The impact of Type 1 SD adaptation results in a change in the number of active antenna ports or antenna structure in general. The RF characteristics, e.g., radiation power, beam pattern, etc., of remaining antenna ports remain same. The impact of Type 2 SD adaptation results in a change in the RF characteristics of antenna ports affected by AE on/off while the number of antenna ports remains the same. The impact of PD adaptation is similar to Type 2 SD adaptation. A gNB can perform any combination of Type 1 SD, Type 2 SD, and PD adaptations together with other time/frequency domain adaptation techniques such as cell DTX/DRX.

Network operation parameters for transmission or reception can be in one or more of a power, spatial, time, or frequency domain.

For example, in a power domain, a first NW operation state can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states can be respectively associated with first and second values of parameter powerControlOffsetSS that provides a power offset (in dB) of non-zero power (NZP) CSI-RS RE to SSS RE. For example, first and second NW operation states can be respectively associated with first and second values of parameter powerControlOffset that provides a power offset (in dB) of PDSCH RE to NZP CSI-RS RE.

For example, in a frequency domain, first and second NW operation states can be respectively associated with first and second values of a parameter locationAndBandwidth that indicates a frequency domain location and a bandwidth for receptions or transmissions by UEs. For example, first and second NW operation states can be respectively associated with first and second values of a parameter BWP-Id for DL and UL. For example, first and second NW operation states can be respectively associated with first and second values of a list of serving cells for active transmission and reception.

For example, in a spatial domain, first and second NW operation states can be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by activeCoresetPoolIndex. For example, first and second NW operation states can be respectively associated with first and second values of an antenna port subset that indicates a list of active antenna ports for CSI calculation and other associated parameters such as codebook subset restriction, rank restriction, the logical antenna size in two-dimension, number of antenna ports, and a list of CSI-RS resources, etc.

For example, in a time domain, first and second NW operation states can be respectively associated with first and second values of a parameter ssb-PeriodicityServingCell that indicates a transmission periodicity in milliseconds for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted. For example, first and second NW operation states can be respectively associated with first and second values of a time pattern, e.g., in terms of periodicity, on-duration, start offset, etc., that indicates cell discontinuous transmission (DTX) or cell discontinuous reception (DRX).

A network may need to assess an impact of adapting network transmission or reception parameters in one or more of a power, spatial, time, or frequency domain prior to executing an actual adaptation by providing multiple CSI report sub-configurations, which correspond to different network adaptation hypotheses, and receiving multiple CSI reports from the UE. In providing multiple CSI report sub-configurations to the UE, there is a need for defining procedures and methods to efficiently associate a set of CSI-RS resources with a CSI report sub-configuration to avoid excessive signaling overhead. When a UE calculating CSI for multiple sub-configurations corresponding to different spatial domain adaptation hypotheses, there is another need for defining procedures and methods for deriving CRI and counting CPU occupancy.

A number of CSI report sub-configurations may correspond to different spatial domain adaptations by adjusting a number of active spatial elements. The CSI report sub-configurations can be further associated with a number of power adaptation values for jointly assessing an impact of network parameter adaptation in both spatial and power domains. Therefore, there is a need for defining procedures and methods to efficiently associate a set of CSI-RS resources and a set of power adaptation values with a CSI report sub-configuration to avoid excessive signaling overhead. When a UE calculating CSI for multiple sub-configurations corresponding to different joint spatial and power domain adaptation hypotheses, there is another need for defining procedures and methods for deriving CRI and counting CPU occupancy.

A PUCCH resource available for a PUCCH transmission with multiple CSI reports corresponding to multiple adaptation hypotheses may not be sufficient to result to a code rate that is smaller than or equal to a configured or indicated code rate for UCI in the PUCCH. Therefore, there is a need for defining procedures and methods to configure more than one PUCCH resources for a given CSI report. Furthermore, even with multiple PUCCH resources, the UE may need to drop some UCI, such as some of the multiple CSI reports, in order for a resulting code rate to be smaller than or equal to a configured or indicated code rate for the multiple PUCCH resources. Therefore, there is yet another need to define prioritization rules for providing multiple CSI reports when some of the multiple CSI reports need to be dropped.

The disclosure relates to a communication system. The disclosure relates to defining functionalities and procedures for reporting CSI that is associated with multiple network operating states (adaptation hypotheses) in one or more of a power, spatial, time, or frequency domain, for example in order to support network energy savings.

The disclosure further relates to associating a first number of CSI-RS resources with a second number of CSI report sub-configurations, calculating CSI for a third number of CSI report sub-configurations, providing the CSI report, and counting CPU.

The disclosure also relates to associating a first number of CSI-RS resources and a second number of transmission power adaptation values with a third number of CSI report sub-configurations, calculating CSI for a fourth number of CSI report sub-configurations and fifth number of transmission power adaptation values, providing the CSI report, and counting CPU.

The disclosure is further related to determining a first number of CSI reports from a second number of CSI report sub-configurations for a PUCCH resource, while satisfying the maximum code rates for UCI reporting using the PUCCH resource, along with CSI dropping rules in order to satisfy the maximum code rates requirements.

Embodiments of the disclosure for reporting CSI associated with multiple network operating states (adaptation hypotheses) in one or more of a power, spatial, time, or frequency domain, for example in order to support network energy savings, are summarized in the following and are fully elaborated further below.

Method and apparatus for associating a first number of CSI-RS resources with a second number of CSI report sub-configurations, calculating CSI for a third number of CSI report sub-configurations, and providing the CSI report.

Method and apparatus for associating a first number of CSI-RS resources and a second number of transmission power values with a third number of CSI report sub-configurations, calculating CSI for a fourth number of CSI report sub-configurations and fifth number of transmission power values, and providing the CSI report.

Method and apparatus for determining a first number of CSI reports from a second number of CSI report sub-configurations for a PUCCH resource, while satisfying the maximum code rates for UCI reporting using the PUCCH resource, along with the CSI dropping rules in order to satisfy the maximum code rates requirements.

A serving gNB can indicate to a UE a number of hypotheses on transmission/reception parameters and the UE can provide to the serving gNB a number of CSI reports according to the indicated hypotheses that correspond to possible network operating states. For a CSI report, a number of sub-configurations associated with network operating states (adaptation hypotheses) can be provided by the serving gNB to the UE. Each sub-configuration describes a hypothesis on the network operation parameters for transmission or reception in one or more of a power, spatial, time, or frequency domain.

The gNB can indicate the UE to perform CSI measurement and reporting according to indicated CSI report sub-configurations. Triggering of CSI reporting can be via DCI in a PDCCH reception, or via MAC CE or RRC IE in a PDSCH reception. The signaling can be UE-specific (such as by DCI/TB with CRC scrambled by C-RNTI or DCI/TB associated with a PDCCH reception in CCEs determined according to a UE-specific search space), UE-group-specific (such as by DCI/TB with CRC that is not scrambled by C-RNTI or DCI/TB associated with a PDCCH reception in CCEs determined according to a common search space), or cell-specific for example via a SIB. For example, a UE can monitor PDCCH for detecting a DCI format that triggers multiple CSI reports, which correspond to a number of CSI report sub-configurations provided in the CSI report configuration, according to a CSS set or a USS set. A list of CSI report sub-configuration indexes for reporting can be indicated in the DCI or by higher layer signaling, such as in a RRC IE or a MAC CE update, as a part of a “trigger state” that is indicated by the DCI among a set of “trigger states.”

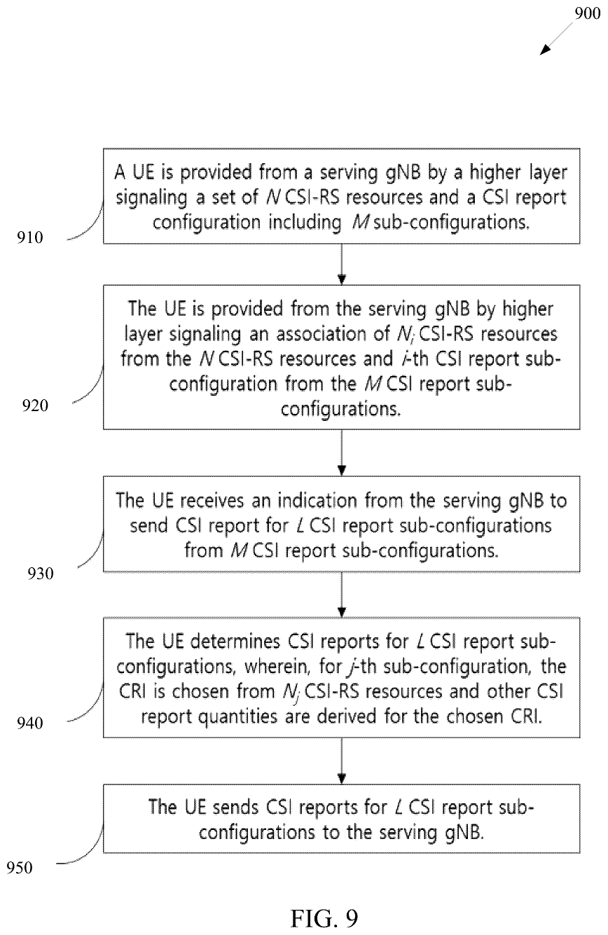

FIG. 9 illustrates a flowchart of a UE method 900 for sending multiple CSI reports according to embodiments of the present disclosure. The method 900 as may be performed by a UE (e.g., 111-116 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

A UE is provided from a serving gNB by higher layer signaling a set of N CSI-RS resources and a CSI report configuration including M sub-configurations 910. The higher layer signaling can be an RRC IE. The set of N CSI-RS resources and the CSI report configuration including M sub-configurations may also be updated by a MAC CE that indicates corresponding subsets of the ones provided in the RRC IE.

As illustrated in FIG. 9, in step 910, a UE is provided from a serving gNB by a higher layer signaling a set of N CSI-RS resources and a CSI report configuration including M sub-configurations. In step 920, the UE is provided from the serving gNB by higher layer signaling an association of Ni CSI-RS resources from the N CSI-RS resources and i-th CSI report sub-configuration from the M CSI report sub-configurations. In step 930, the UE receives an indication from the serving gNB to send CSI report for L CSI report sub-configurations from M CSI report sub-configurations. In step 940, the UE determines CSI reports for L CSI report sub-configurations, wherein for j-th sub-configurations, the CRI is chosen from Nj CSI-RS resources and other CSI report quantities are derived for the chosen CRI. In step 950, the UE sends CSI reports for L CSI report sub-configurations to the serving gNB.

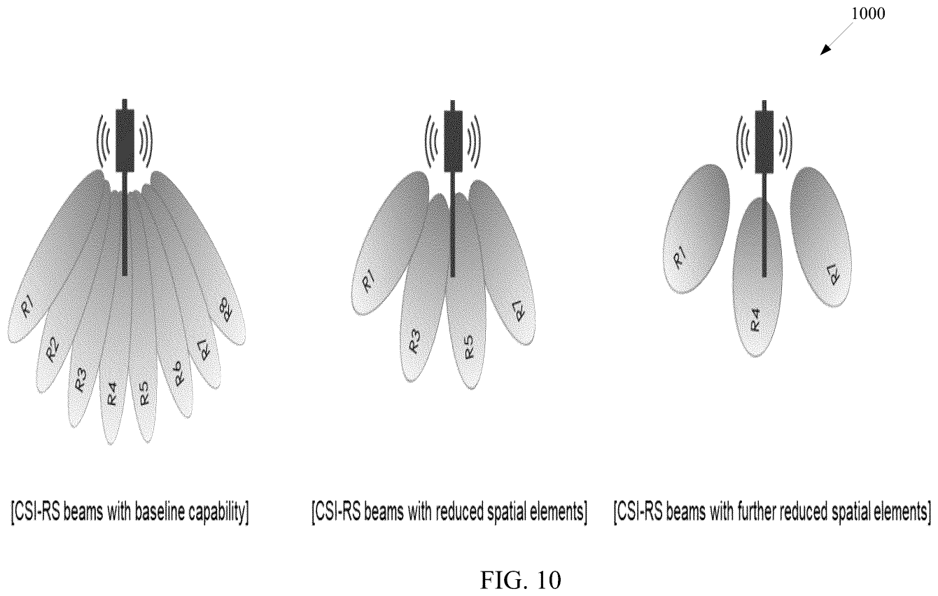

FIG. 10 illustrates an example of CSI-RS beams with reduced spatial elements 1000 according to embodiments of the present disclosure. An embodiment of the CSI-RS beams with reduced spatial elements 1000 shown in FIG. 10 is for illustration only.

As exemplified in FIG. 10, different sub-configurations may correspond to different spatial domain adaptations by adjusting a number of active spatial elements. In the example in FIG. 10, the CSI report configuration provided to the UE includes M=3 sub-configurations, wherein each sub-configuration is associated with a number of CSI-RS resources for channel measurements.

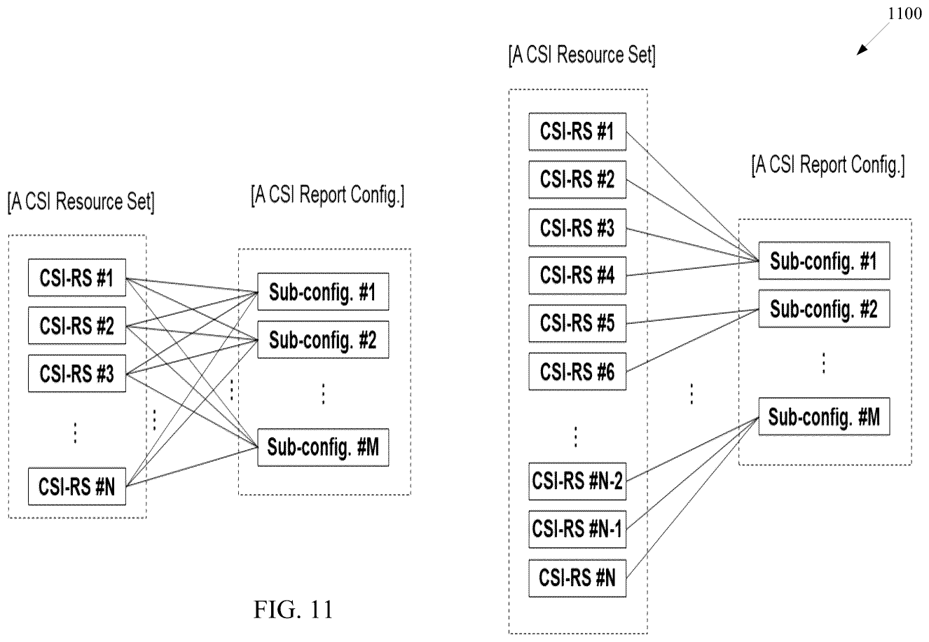

FIG. 11 illustrates an example of association of CSI-RS resources with CSI report sub-configurations 1100 according to embodiments of the present disclosure. An embodiment of the association of CSI-RS resources with CSI report sub-configurations 1100 shown in FIG. 11 is for illustration only.

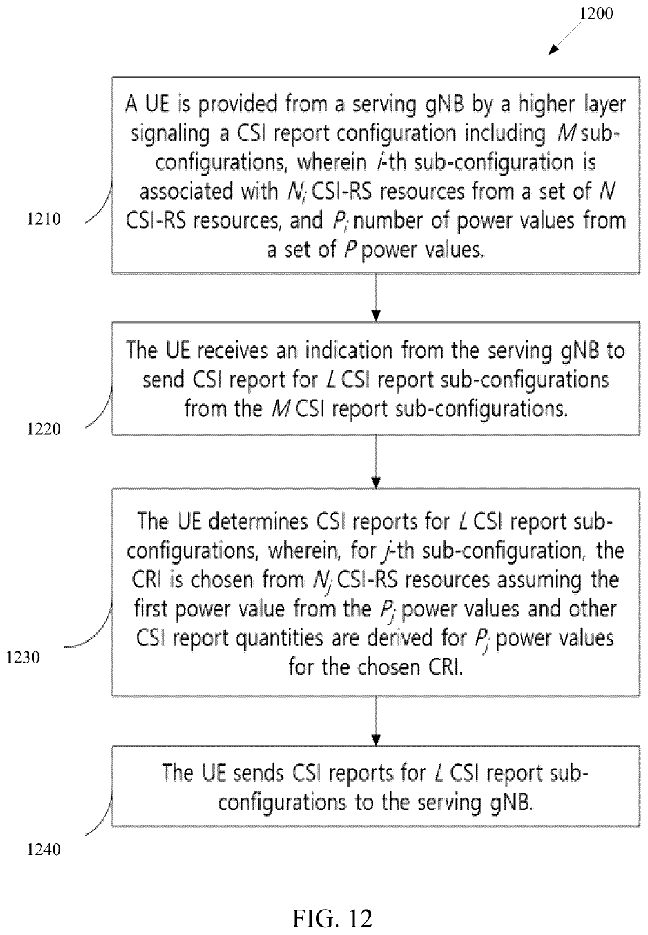

FIG. 12 illustrates a flowchart of a UE method 1200 for providing multiple CSI reports for joint spatial and power domain adaptations according to embodiments of the present disclosure. The method 1200 as may be performed by a UE (e.g., 111-116 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

In one example, a CSI-RS resource within a CSI-RS resource set can be associated with more than one CSI report sub-configurations. In another example, a CSI-RS resource can be associated with only one CSI report sub-configuration. In the former case, a CSI-RS resource is associated with multiple different network operating states (adaptation hypotheses), while in the latter case, a CSI-RS resource is associated with only one network operating state (adaptation hypothesis). A number of CSI-RS resources associated with each CSI report sub-configuration can be separately indicated and may be same or different. In FIG. 11, Nᵢ=N, ∀i∈{1, . . . , M} for the example on the left-hand side, and Σᵢ^{M} Nᵢ=N for the example on the right-hand side.

In one example, a set of CSI-RS resources associated with a CSI report sub-configuration is provided to the UE via a list of ordinal numbers within the CSI-RS resource set. In another example, a set of CSI-RS resources associated with a CSI report sub-configuration is provided to the UE via a bitmap of size N, wherein k-th bit within the bitmap indicates true/false association between the k-th CSI-RS resource with the corresponding CSI report sub-configuration. In another example, a set of CSI-RS resources associated with a CSI report sub-configuration is provided to the UE via a list of NZP-CSI-RS-ResourceId of CSI-RS resources included in the CSI-RS resource set.

In another example, a common set of CSI-RS resources can be associated with all M CSI report sub-configurations. The common set of CSI-RS resources is indicated to the UE, for example by higher layers such as an RRC IE. If the common set of CSI-RS resources is equal to the full set N CSI-RS resources, such an indication may be skipped and CSI reporting for different network operating states can be based on the indication for the full set of N CSI-RS resources. In one example, one set of CSI-RS resources is associated with a given CSI report sub-configuration. In another example, more than one sets of CSI-RS resources are associated with a CSI report sub-configuration, and the UE is provided an index to the sets of CSI-RS resources for CSI reporting for one or more serving cells.

As illustrated in FIG. 12, in step 1210, the UE is provided from a serving gNB by a higher layer signaling a CSI report configuration including M sub-configurations, wherein i-th sub-configuration is associated with Nᵢ CSI-RS resources from a set of N CSI-RS resources, and Pᵢ number of power values from a set of P power values. In step 1220, the UE receives an indication from the serving gNB to send CSI report for L CSI report sub-configurations from the M CSI report sub-configurations.

The UE receives an indication from the serving gNB to provide a CSI report for L CSI report sub-configurations from M CSI report sub-configurations 1230.

The UE determines CSI reports for L CSI report sub-configurations, wherein, for j-th sub-configuration, a CRI is selected from Nj CSI-RS resources and other CSI report quantities are derived for the CRI 1230.

In one example, the CRI for the j-th sub-configuration is reported using ┌log₂ N┐ bits, where N is the number of CSI-RS resources in the corresponding CSI-RS resource set provided to the UE. In another example, the CRI for the j-th sub-configuration is reported using ┌log₂ N┐ bits, where Nⱼ is the number of CSI-RS resources associated with the j-th CSI report sub-configuration. In another example, the CRI for the j-th sub-configuration is reported using ┌log₂ Nₘₐₓ┐ bits, where Nₘₐₓ is a maximum number of CSI-RS resources that can be associated with any CSI report sub-configurations within the CSI report configuration. Other CSI report quantities, such as one or more of RI, PMI, CQI, i1, RSRP, SINR, as applicable, are calculated for the selected CRI for a CSI report corresponding to the j-th report sub-configuration. The UE reports a total of L CRIs and a set of L other CSI report quantities for L CSI report sub-configurations. The CSI processing unit (CPU) occupancy can be counted as O_{CPU}=Σ_{j∈L}Nⱼ, where L is the set of L CSI report sub-configurations from M sub-configurations indicated for CSI reporting.

If the UE is provided a common set of CSI-RS resources for all the M CSI report sub-configurations or for L triggered CSI report sub-configurations, the UE may report a single CRI that is common across multiple CSI reports. In one example, the UE selects the single CRI based on the CSI report for the first sub-configuration. In this example, the CPU occupancy can be counted as O_{CPU}=N₁ₛₜ+L−1, where N₁ₛₜ is the number of CSI-RS resources associated with the first sub-configuration, which may be same for other sub-configurations. In another example, the UE selects the single CRI based on all CSI reports for L sub-configurations. In this example, the CPU occupancy can be counted as O_{CPU}=Σ_{j∈L}Nⱼ. Other CSI report quantities are calculated for the selected single CRI. Therefore, in this example, the UE reports a single CRI and a set of L other CSI report quantities for L CSI report sub-configurations.

The UE provides the CSI reports for the L CSI report sub-configurations to the serving gNB 1240, for example in a PUCCH or in a PUSCH.

A number of CSI report sub-configurations describing network operating states (adaptation hypotheses) can be provided by a serving gNB to a UE, wherein different sub-configurations may correspond to different spatial domain operating states (adaptations) by adjusting a number of active spatial elements. The CSI report sub-configurations can be further associated with a number of transmission power values for possible adaptation, for example to assess an impact of adaptation for network operating states in both the spatial and power domains.

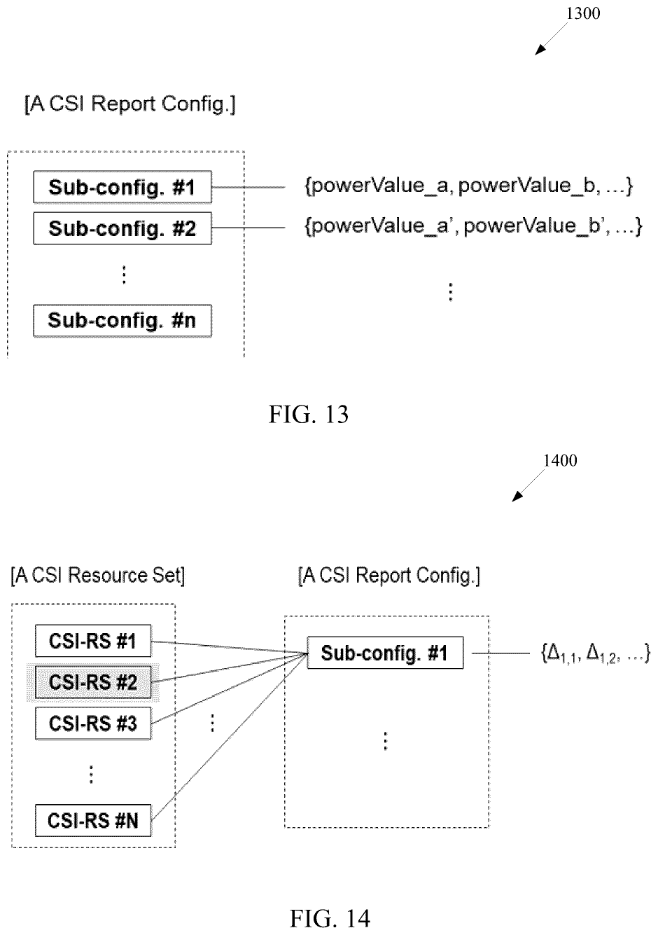

FIG. 13 illustrates an example of association of multiple power values with CSI report sub-configurations 1300 according to embodiments of the present disclosure. An embodiment of the association of multiple power values with CSI report sub-configurations 1300 shown in FIG. 13 is for illustration only.

A UE is provided from a serving gNB by a higher layer signaling a CSI report configuration including M sub-configurations, wherein i-th sub-configuration is associated with Ni CSI-RS resources from a set of N CSI-RS resources, and Pi number of transmission power values from a set of P transmission power values 1210.

The transmission power values can be one or more of SSB transmission powers, which can be provided by respective values of ss-PBCH-BlockPower, CSI-RS transmission powers, which can be provided by respective values of powerControlOffsetSS, and PDSCH transmission powers, which can be provided by respective values of powerControlOffset. In one example, the UE is provided from the serving gNB a set of Pᵢ transmission power values from the set of P transmission power values for the i-th CSI report sub-configuration, which can be indicated using a bitmap of size P or a list of Pᵢ indexes from the set of P transmission power values. Alternatively, each CSI report sub-configuration can be directly associated with a set of Pᵢ transmission power values, which can be from separate sets of P transmission power values.

The UE receives an indication from the serving gNB to provide a CSI report for L CSI report sub-configurations from the M CSI report sub-configurations 1220. For each of the L CSI report sub-configurations, the UE may be further indicated to provide CSI reports corresponding to all associated transmission power values or to only a subset of transmission power values. For instance, for j-th CSI report sub-configuration, the UE can be indicated to provide CSI reports corresponding to the entire set of Pⱼ transmission power values or to only a subset of transmission power values from the set of Pⱼ transmission power values. In one example, the UE receives an indication for a subset of transmission power values from the serving gNB via a PDCCH providing DCI, wherein the DCI indicates one or more indexes of transmission power values from the set of Pⱼ transmission power values. A new DCI format can be defined or an existing DCI format, e.g., DCI format 0_1, can be extended to include additional fields indicating a subset of transmission power values.

The DCI format can also be associated with a new/dedicated RNTI and provided by a PDCCH that a UE receives according to a common search space. The UE can then also be provided a location for the indication in the DCI format, for example to enable different indications to different groups of UEs and, for example, obtain CSI reports only from UEs that may require enhanced coverage or data rates. Alternatively, a subset of transmission power values for a given CSI report sub-configuration can be defined as a part of “trigger states” and provided by the serving gNB to the UE by higher layer signaling, and a “trigger state” can be indicated to the UE using a “CSI request” field in the DCI. In another example, the UE receives an indication on a subset of transmission power values from the serving gNB via PDSCH providing MAC-CE or RRC information element, which includes one or more indexes of transmission power values from the set of Pⱼ transmission power values. A MAC-CE format, e.g., “SP CSI reporting on PUCCH Activation/Deactivation” MAC CE, can be extended to include additional fields to indicate those indexes, or a new MAC-CE format can be defined.

FIG. 14 illustrates an example of power offset values via a differential value for CSI-RS resources associated with a CSI report sub-configuration 1400 according to embodiments of the present disclosure. The differential value can be separately indicated and applied per CSI-RS resource or commonly indicated and applied for the set of CSI-RS resources associated with the sub-configuration. An embodiment of the power offset values via a differential value for CSI-RS resources associated with a CSI report sub-configuration 1400 shown in FIG. 14 is for illustration only.

For a CRI chosen assuming a given set of powerControlOffset values for the CSI-RS resources associated with a given CSI report sub-configuration, the network may indicate a UE to report additional CSI reports for the CRI with different powerControlOffset assumptions. For instance, consider that CSI-RS #2 is chosen for CRI assuming powerControlOffset values provided in the CSI report sub-configuration #1 as shown in FIG. 14. For the chosen CSI-RS #2, the serving gNB may explicitly indicate the UE to provide CSI reports for powerControlOffset values in addition to the value assume for CRI selection.

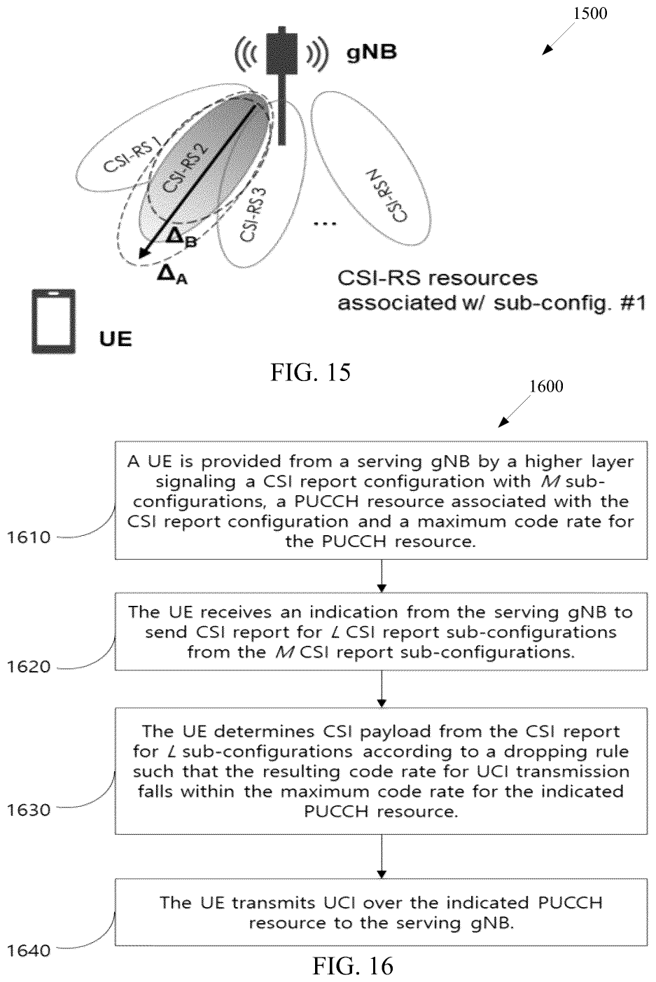

FIG. 15 illustrates an example of CSI reporting for a chosen CRI with additional PD adaptation hypotheses 1500 according to embodiments of the present disclosure. An embodiment of the CSI reporting for a chosen CRI with additional PD adaptation hypotheses 1500 shown in FIG. 15 is for illustration only.

FIG. 16 illustrates a flowchart of a UE method 1600 for providing multiple CSIs using PUCCH with a dropping rule according to embodiments of the present disclosure. The method 1600 as may be performed by a UE (e.g., 111-116 as illustrated in FIG. 1). An embodiment of the method 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

As illustrated in FIG. 16, in step 1610, a UE is provided from a serving gNB by a higher layer signaling a CSI report configuration with M sub-configurations, a PUCCH resource associated with the CSI report configuration and a maximum code rate for the PUCCH resource. In step 1620, the UE receives an indication from the serving gNB to send CSI report for L CSI report sub-configurations from the M CSI report sub-configurations.

The UE determines CSI reports for L CSI report sub-configurations, wherein, for the j-th sub-configuration, the CRI is chosen from Nⱼ CSI-RS resources assuming the first transmission power value from the set of Pⱼ transmission power values and other CSI report quantities are derived for Pⱼ transmission power values for the selected CRI 1630. That is, if the UE is provided from the serving gNB more than one transmission power values according to 1620, CSI for transmission power values other than the first transmission power value is derived for the CSI-RS resource selected from N, CSI-RS resources for the first transmission power value. In this example, the CPU occupancy can be counted as O_{CPU}=Σ_{j∈L}Nⱼ+Pⱼ′−1, where Pⱼ′ is the number of transmission power values that the UE is indicated to provide corresponding CSI reports, which can be smaller than or equal to Pⱼ.

The UE provides CSI reports for L CSI report sub-configurations to the serving gNB 1640.

There are two alternatives in providing powerControlOffset values as follows, along with detailed aspects such as whether to provide absolute value or differential value, etc. In one example, a UE is provided with multiple powerControlOffset values in the CSI report configuration such as in each sub-configuration. In another example, a UE is provided with multiple powerControlOffset values in the CSI-RS resource configuration.

When a UE is provided with multiple powerControlOffset values in the CSI report configuration, the powerControlOffset value itself can be provided for each CSI-RS resource associated with a given CSI report sub-configuration in each CSI report sub-configuration, wherein the powerControlOffset values provided in a CSI report sub-configuration overrides the powerControlOffset provided in the respective CSI-RS resource configurations.

In another example, differential values to the value configured in the CSI-RS resource, i.e., powerControlOffset_delta, rather than the powerControlOffset value itself, can be provided for CSI-RS resources associated with a given CSI report sub-configuration in each CSI report sub-configuration. The powerControlOffset_delta can be provided per CSI-RS resources associated with a CSI report sub-configuration. Alternatively, a common value can be provided for a CSI report sub-configuration, which applies to all the associated CSI-RS resources.

For instance, powerControlOffset_delta is provided per CSI-RS resource associated with a CSI report sub-configuration. As an example, for CSI report sub-configuration #m, the UE assumes powerControlOffset values {powerControlOffset_{m,1}+Δ_{m,1},powerControlOffset_{m,2}+Δ_{m,2}, . . . } for the associated CSI-RS resources, where powerControlOffset_{m,1} and Δ_{m,1} are the powerControlOffset value and the powerControlOffset_delta for the 1^{st} CSI-RS resource associated with m^{th} CSI report sub-configuration, respectively.

Similarly, powerControlOffset_delta is provided per CSI report sub-configuration, which applies to all the associated CSI-RS resources commonly. As an example, for CSI report sub-configuration #m, the UE assumes powerControlOffset values {powerControlOffset_{m,1}+Δₘ, powerControlOffset_{m,2}+Δₘ, . . . } for the associated CSI-RS resources, where Δₘ is the common powerControlOffset_delta value, which applies to all the CSI-RS resources associated with m^{th} CSI report sub-configuration.

The serving gNB may explicitly indicate the UE in the CSI report configuration, such as in each sub-configuration, to report CSI for additional power offset values for a chosen CRI, along with a set of additional power offset values. The additional powerControlOffset values itself can be provided in each CSI report sub-configuration. Alternatively, differential values, i.e., {Δ_{A}, Δ_{B}, . . . }, to the value configured in the corresponding CSI-RS resource or to the value assumed when selecting CRI, can be indicated in each CSI report sub-configuration. When a CSI report sub-configuration is associated with N CSI-RS resources, the CPU counting is N for the initial CRI selection. The CSI reporting for an additional powerControlOffset value for a chosen CRI can be additionally counted as 1 CPU as the UE directly calculates CSI for the chosen CRI.

When, for example, a UE multiplexes in a PUCCH using a PUCCH resource several UCI types, including CSI reports associated with different network operating states, a number of REs of the PUCCH resource for the UCI multiplexing may not be sufficient to achieve a target UCI reliability, i.e., a resulting code rate exceeds a (maximum) code rate the UE is indicated by L1 or higher layers. Then, in order to reduce a code rate for the UCI, the UE can drop some of the UCI. In case the UE reports multiple CSIs corresponding to multiple network operating states (adaptation hypotheses), together with HARQ-ACK information or SR, a dropping rule for the multiple CSIs needs to be defined. The below description is provided for CSI reporting using PUCCH. However, the general principle can also apply for CSI reporting using PUSCH.

A UE is provided from a serving gNB by a higher layer signaling a CSI report configuration with M sub-configurations, which may be further associated with one or more transmission power adaptation values, a PUCCH resource associated with the CSI report configuration and a maximum code rate for the UCI reporting 1610. The maximum code rate can be provided in the PUCCH-Config.

The UE receives an indication from the serving gNB to provide CSI reports for L CSI report sub-configurations from the M CSI report sub-configurations 1620.

The UE determines CSI payload from the CSI report for L sub-configurations according to a dropping rule that can be provided with a code rate that is not larger than the maximum code rate 1630. In one approach, a UE drops CSIs from the CSI report for L sub-configurations sequentially, for example in a descending order of the sub-configuration index until a resulting code rate is smaller than or equal to the indicated code rate. In another example, the UE may be provided from the serving cell a particular order of dropping CSIs from the L (or M) CSI report sub-configuration indexes. In the CSI payload, the UE may indicate an actual number of reported CSIs, which may be different from the requested number of CSI report sub-configurations L, and a list of reported sub-configuration indexes.

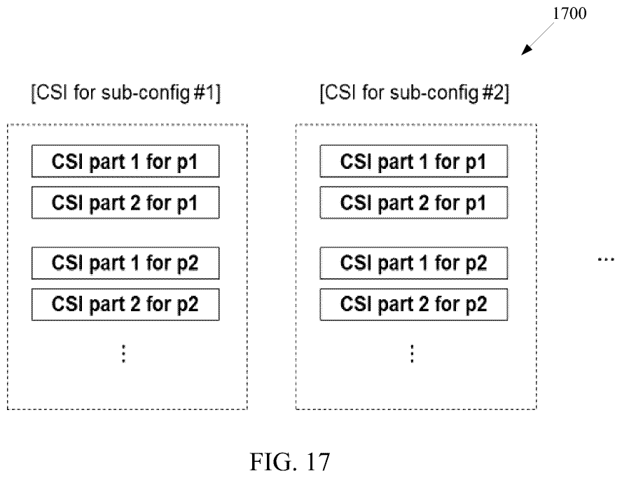

FIG. 17 illustrates an example of UE CSI payload corresponding to multiple CSI report sub-configurations and power adaptation values 1700 according to embodiments of the present disclosure. An embodiment of the UE CSI payload corresponding to multiple CSI report sub-configurations and power adaptation values 1700 shown in FIG. 17 is for illustration only.

A CSI payload can include multiple CSI reports for multiple CSI report sub-configurations, wherein a CSI report for each sub-configuration may include multiple sets of CSI report quantities for respective transmission power values corresponding to network operating states. Each CSI report for a given transmission power adaptation value and for a given sub-configuration may include one part or two parts, such as Part 1 and Part 2. As an example, for type I CSI sub-band reporting using PUCCH format 3 or 4, the payload is split into two parts. The first part contains RI (if reported), CRI (if reported), and CQI for the first codeword. The second part contains PMI (if reported), LI (if reported) and CQI for the second codeword (if reported) when RI>4.

When a CSI report includes two parts, the following alternative priority rules can apply for dropping CSI reports when a resulting UCI code rate may be larger than an indicated maximum code rate for a PUCCH resource: (1) Alt 1) CSI components are dropped in the sub-configuration level first, dropped in the transmission power level within the sub-configuration next, and then CSI Part 2 or a part of CSI Part 2 is dropped prior to CSI Part 1 for a given CSI report; (2) Alt 2) CSI components are dropped in the transmission power-level first across sub-configurations, dropped in the sub-configuration level next, and then CSI Part 2 or a part of CSI Part 2 is dropped prior to CSI Part 1 for a given CSI; (3) Alt 3) CSI Part 2 or a part of CSI Part 2 is dropped first, dropped in the transmission power level across sub-configurations next, and then dropped in the sub-configuration level; and (4) Alt 4) CSI Part 2 or a part of CSI Part 2 is dropped first, dropped in the in the sub-configuration level next, and then dropped in the transmission power level within the sub-configuration.

When the CSI includes one part, the following alternative priority rules can apply for dropping CSI given a maximum code rate for a PUCCH resource: (1) Alt 1) CSI is dropped in the sub-configuration level first, and then dropped in the transmission power level within the sub-configuration and (2) Alt 2) CSI is dropped in the transmission power-level first across sub-configurations, and then dropped in the sub-configuration level.

The UE transmits UCI over the indicated PUCCH resource to the serving gNB 1640.

The above descriptions assumed that, when the UE has HARQ-ACK information, or scheduling request (SR), or first CSI reports associated with scheduling on a serving cell, in addition to second CSI reports associated with network operating states, the UE prioritizes the HARQ-ACK information/SR/first CSI reports and starts dropping parts of the second CSI reports in order to achieve a code rate for the remaining reported UCI that is not larger than the maximum code rate. However, it is also possible that the UE prioritizes the second CSI reports over one or more of the HARQ-ACK information/SR/first CSI reports. For example, the UE can prioritize multiplexing in the PUCCH of the second CSI report and drop (not multiplex) parts of the first CSI reports. The UE behavior for the prioritization of CSI reports associated with network operating states relative to other UCI in a PUCCH can be defined in the specifications of the system operation or can be indicated from a serving gNB by higher layers.

In one embodiment, for a CSI report with CQI that is below an indicated or predetermined threshold, the UE may drop the CSI report. In this case, the CSI report payload, such as a number of CSI reports, is not known to the gNB and can be indicated by the UE using separate corresponding information in the report. For instance, the UE may indicate an actual number of reported CSIs and a list of reported sub-configuration indexes. Furthermore, the serving gNB may provide more than one PUCCH resources to the UE for the corresponding CSI report as the CSI report payload is not determined in advance. The UE then selects the PUCCH resource with the smaller number of RBs or the smallest maximum code rate that is larger than the resulting code rate for reporting the CSI using that resource.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE) to report channel state information (CSI), the method comprising:
receiving:
first information related to a CSI reference signal (CSI-RS) resource set including one or more non-zero power CSI-RSs (NZP CSI-RSs) on a cell,
second information related to a CSI report including a first number of CSI report sub-configurations corresponding to respective CSI sub-reports,
third information related to association between the one or more NZP CSI-RSs and the respective first number of CSI report sub-configurations,
fourth information related to indicating a second number of CSI report sub-configurations from the first number of CSI report sub-configurations, wherein the fourth information is provided by:
a downlink control information (DCI) format by indicating an index from one or more lists of indexes from the first number of CSI report sub-configurations,
a medium access control control element (MAC CE), or
a radio resource control (RRC) message,
fifth information related to an uplink (UL) channel for transmitting the CSI report, and
the one or more NZP CSI-RSs based on the first information;
determining the second number of CSI sub-reports based on the second information, the third information, the fourth information, and the reception of the one or more NZP CSI-RSs, wherein the determination of a CSI sub-report is based on a subset of NZP CSI-RSs associated with a corresponding CSI sub-configuration; and
transmitting the UL channel with the CSI report including the second number of CSI sub-reports.

2. The method of claim 1, wherein:
the association between the one or more NZP CSI-RSs and the respective first number of CSI report sub-configurations is provided by a list of NZP CSI-RS indexes from the CSI-RS resource set,
the list of NZP CSI-RS indexes is provided in a CSI report sub-configuration, and
an NZP CSI-RS resource is associated with at most one CSI report sub-configuration.

3. The method of claim 1, wherein each of the first number of CSI report sub-configurations is associated with all the one or more NZP CSI-RSs in the CSI-RS resource set when a list of NZP CSI-RS indexes from the CSI-RS resource set is not provided in the first number of CSI report sub-configurations.

4. The method of claim 1, wherein:
a bitwidth of a CSI-RS resource indicator (CRI) field for a CSI sub-report is determined as ┌log₂ K┐, and
K is a number of NZP CSI-RSs associated with the corresponding CSI report sub-configuration when the second information indicates to report CRI.

5. The method of claim 1, wherein a CSI sub-report includes two parts:
a first part includes a rank indicator (RI), a CSI-RS resource indicator (CRI), and a channel quality indicator (CQI) for a first codeword when the second information indicates to report respective report quantities for the corresponding CSI report sub-configuration, and
a second part includes a CQI for a second codeword when the RI is larger than 4, a layer indicator (LI), and precoding matrix indicator (PMI) when the second information indicates to report the respective report quantities for the corresponding CSI report sub-configuration.

6. The method of claim 1, further comprising:
determining CSI processing unit (CPU) occupancy, wherein the CPU occupancy is counted by summing a number of NZP CSI-RSs associated with a corresponding CSI report sub-configuration over the second number of CSI report sub-configurations.

7. The method of claim 1, wherein:
a CSI report sub-configuration includes a power offset value, and
the power offset value is commonly applied to respective power offset values of a physical downlink shared channel (PDSCH) resource element (RE) to NZP CSI-RS RE of the one or more NZP CSI-RSs associated with the first number of CSI report sub-configurations.

8. A user equipment (UE), comprising:
a transceiver configured to receive:
first information related to a channel state information reference signal (CSI-RS) resource set including one or more non-zero power CSI-RSs (NZP CSI-RSs) on a cell,
second information related to a CSI report including a first number of CSI report sub-configurations corresponding to respective CSI sub-reports,
third information related to association between the one or more NZP CSI-RSs and the respective first number of CSI report sub-configurations,
fourth information related to indicating a second number of CSI report sub-configurations from the first number of CSI report sub-configurations, wherein the fourth information is provided by:
a downlink control information (DCI) format by indicating an index from one or more lists of indexes from the first number of CSI report sub-configurations,
a medium access control control element (MAC CE), or
a radio resource control (RRC) message,
fifth information related to an uplink (UL) channel for transmitting the CSI report, and
the one or more NZP CSI-RSs based on the first information; and
a processor operably coupled to the transceiver, the processor configured to determine the second number of CSI sub-reports based on the second information, the third information, the fourth information, and the reception of the one or more NZP CSI-RSs, wherein the determination of a CSI sub-report is based on a subset of NZP CSI-RSs associated with a corresponding CSI sub-configuration,
wherein the transceiver is further configured to transmit the UL channel with the CSI report including the second number of CSI sub-reports.

9. The UE of claim 8, wherein:
the association between the one or more NZP CSI-RSs and the respective first number of CSI report sub-configurations is provided by a list of NZP CSI-RS indexes from the CSI-RS resource set,
the list of NZP CSI-RS indexes is provided in a CSI report sub-configuration, and
an NZP CSI-RS resource is associated with at most one CSI report sub-configuration.

10. The UE of claim 8, wherein each of the first number of CSI report sub-configurations is associated with all the one or more NZP CSI-RSs in the CSI-RS resource set when a list of NZP CSI-RS indexes from the CSI-RS resource set is not provided in the first number of CSI report sub-configurations.

11. The UE of claim 8, wherein:
a bitwidth of a CSI-RS resource indicator (CRI) field for a CSI sub-report is determined as ┌log₂ K┐, and
K is a number of NZP CSI-RSs associated with the corresponding CSI report sub-configuration when the second information indicates to report CRI.

12. The UE of claim 8, wherein a CSI sub-report includes two parts:
a first part includes a rank indicator (RI), a CSI-RS resource indicator (CRI), and a channel quality indicator (CQI) for a first codeword when the second information indicates to report respective report quantities for the corresponding CSI report sub-configuration, and
a second part includes a CQI for a second codeword when the RI is larger than 4, a layer indicator (LI), and precoding matrix indicator (PMI) when the second information indicates to report the respective report quantities for the corresponding CSI report sub-configuration.

13. The UE of claim 8, wherein:
the processor is further configured to determine CSI processing unit (CPU) occupancy, and
the CPU occupancy is counted by summing a number of NZP CSI-RSs associated with a corresponding CSI report sub-configuration over the second number of CSI report sub-configurations.

14. The UE of claim 8, wherein:
a CSI report sub-configuration includes a power offset value, and
the power offset value is commonly applied to respective power offset values of a physical downlink shared channel (PDSCH) resource element (RE) to NZP CSI-RS RE of the one or more NZP CSI-RSs associated with the first number of CSI report sub-configurations.

15. A base station (BS), comprising:
a processor; and
a transceiver operably coupled to the processor, the transceiver configured to:
transmit:
first information related to a channel state information reference signal (CSI-RS) resource set including one or more non-zero power CSI-RSs (NZP CSI-RSs) on a cell,
second information related to a CSI report including a first number of CSI report sub-configurations corresponding to respective CSI sub-reports,
third information related to association between the one or more NZP CSI-RSs and the respective first number of CSI report sub-configurations,
fourth information related to indicating a second number of CSI report sub-configurations from the first number of CSI report sub-configurations, wherein the fourth information is provided by:
a downlink control information (DCI) format by indicating an index from one or more lists of indexes from the first number of CSI report sub-configurations,
a medium access control control element (MAC CE), or
a radio resource control (RRC) message,
fifth information related to an uplink (UL) channel for transmitting the CSI report, and
the one or more NZP CSI-RSs based on the first information; and
receive the UL channel with the CSI report including the second number of CSI sub-reports, wherein a CSI sub-report is based on a subset of NZP CSI-RSs associated with a corresponding CSI sub-configuration.

16. The BS of claim 15, wherein:
the association between the one or more NZP CSI-RSs and the respective first number of CSI report sub-configurations is provided by a list of NZP CSI-RS indexes from the CSI-RS resource set,
the list of NZP CSI-RS indexes is provided in a CSI report sub-configuration, and
an NZP CSI-RS resource is associated with at most one CSI report sub-configuration.

17. The BS of claim 15, wherein each of the first number of CSI report sub-configurations is associated with all the one or more NZP CSI-RSs in the CSI-RS resource set when a list of NZP CSI-RS indexes from the CSI-RS resource set is not provided in the first number of CSI report sub-configurations.

18. The BS of claim 15, wherein:
a bitwidth of a CSI-RS resource indicator (CRI) field for a CSI sub-report is ┌log₂ K┐, and
K is a number of NZP CSI-RSs associated with the corresponding CSI report sub-configuration when the second information indicates to report CRI.

19. The BS of claim 15, wherein a CSI sub-report includes two parts:
a first part includes a rank indicator (RI), a CSI-RS resource indicator (CRI), and a channel quality indicator (CQI) for a first codeword when the second information indicates to report respective report quantities for the corresponding CSI report sub-configuration, and
a second part includes a CQI for a second codeword when the RI is larger than 4, a layer indicator (LI), and precoding matrix indicator (PMI) when the second information indicates to report the respective report quantities for the corresponding CSI report sub-configuration.

20. The BS of claim 15, wherein:
a CSI report sub-configuration includes a power offset value, and
the power offset value is commonly applied to respective power offset values of a physical downlink shared channel (PDSCH) resource element (RE) to NZP CSI-RS RE of the one or more NZP CSI-RSs associated with the first number of CSI report sub-configurations.
